(19) United States
(12) Patent Application Publication
(10) Pub. No.: US 2016/0147738 A1
(43) Pub. Date: May 26, 2016

(54) SYSTEM AND METHOD FOR MULTI-LINGUAL TRANSLATION

(71) Applicants: Jeff Geurts, Kitchener (CA); Daryl McMillan, Waterloo (CA); David Lockhart, Waterloo (CA)

(72) Inventors: Jeff Geurts, Kitchener (CA); Daryl McMillan, Waterloo (CA); David Lockhart, Waterloo (CA)

(21) Appl. No.: 14/552,452

(22) Filed: Nov. 24, 2014

(51) Int. Cl. G06F 17/28

(52) U.S. Cl. CPC G06F 17/28

(57) ABSTRACT

Systems and methods for multi-lingual translation of content for an electronic learning platform that involve receiving translated content in a translation language, wherein the translated content is generated based on content in a source language; linking the content in the source language to the translated content in the translation language; receiving an update to the content in the source language; and receiving a corresponding update to the translated content in the translation language using the linking between the content and the translated content.

### FIELD

The embodiments described herein relate to systems and methods for translation, and more particularly to systems and methods for multi-lingual translation of content within an electronic learning platform.

### INTRODUCTION

Electronic learning (also called e-Learning or eLearning) generally refers to education or learning where users (e.g. learners, instructors, administrative staff) engage in education related activities using computers and other computing devices. For example, learners may enroll or participate in a course or program of study offered by an educational institution (e.g. a college, university or grade school) through a web interface that is accessible over the Internet. Similarly, learners may receive assignments electronically, participate in group work and projects by collaborating online, and be graded based on assignments and examinations that are submitted using an electronic drop box.

Electronic learning is not limited to use by educational institutions, however, and may also be used in governments or in corporate environments. For example, employees at a regional branch office of a particular company may use electronic learning to participate in a training course offered by their company's head office without ever physically leaving the branch office.

Electronic learning can also be an individual activity with no institution driving the learning. For example, individuals may participate in self-directed study (e.g. studying an electronic textbook or watching a pre-recorded or live webcast of a lecture) that is not associated with a particular institution or organization.

Electronic learning often occurs without any face-to-face interaction between the users in the educational community. Accordingly, electronic learning overcomes some of the geographic limitations associated with more traditional learning methods, and may eliminate or greatly reduce travel and relocation requirements imposed on users of educational services.

Furthermore, because course materials can be offered and consumed electronically, there are fewer physical restrictions on learning. For example, the number of learners that can be enrolled in a particular course may be practically limitless, as there may be no requirement for physical facilities to house the learners during lectures. Furthermore, learning materials (e.g. handouts, textbooks, etc.) may be provided in electronic formats so that they can be reproduced for a virtually unlimited number of learners. Finally, lectures may be recorded and accessed at varying times (e.g. at different times that are convenient for different users), thus accommodating users with varying schedules, and allowing users to be enrolled in multiple courses that might have a scheduling conflict when offered using traditional techniques.

Users of electronic learning services may speak different languages. There exists a need for improved systems and methods for multi-lingual translation of content within an electronic learning platform, or at least alternatives.

### DRAWINGS

Various embodiments will now be described, by way of example only, with reference to the following drawings, in which:

FIG. 1 is a schematic diagram of an electronic learning system for multi-lingual translation of content for an electronic learning system according to some embodiments;

FIG. 2 is another schematic diagram of an electronic learning system for multi-lingual translation of content for an electronic learning system according to some embodiments;

FIG. 3 is a schematic diagram of content records according to some embodiments;

FIG. 4 is another schematic diagram of content records according to some embodiments;

FIG. 5 is a flow diagram of a method for multi-lingual translation of content for an electronic learning platform according to some embodiments; and

FIG. 6 is another flow diagram of a method for multi-lingual translation of content for an electronic learning platform according to some embodiments.

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

### DESCRIPTION OF VARIOUS EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, tablet, UMPC device, and wireless hypermedia device or any other computing device capable of being configured to carry out the methods described herein.

Program code is applied to input data to perform the functions described herein and to generate output information. The output information is applied to one or more output devices. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including as volatile or non-volatile memory provided on optical, magnetic or electronic storage media, such as for example one or more diskettes, compact disks, tapes, chips, and the like. Non-transitory computer-readable media comprise all computer-readable media, with the exception being a transitory, propagating signal. The term “non-transitory” is not intended to exclude computer readable media such as a volatile memory or RAM, where the data stored thereon is only temporarily stored. The computer useable instructions may also be in various forms, including compiled and non-compiled code.

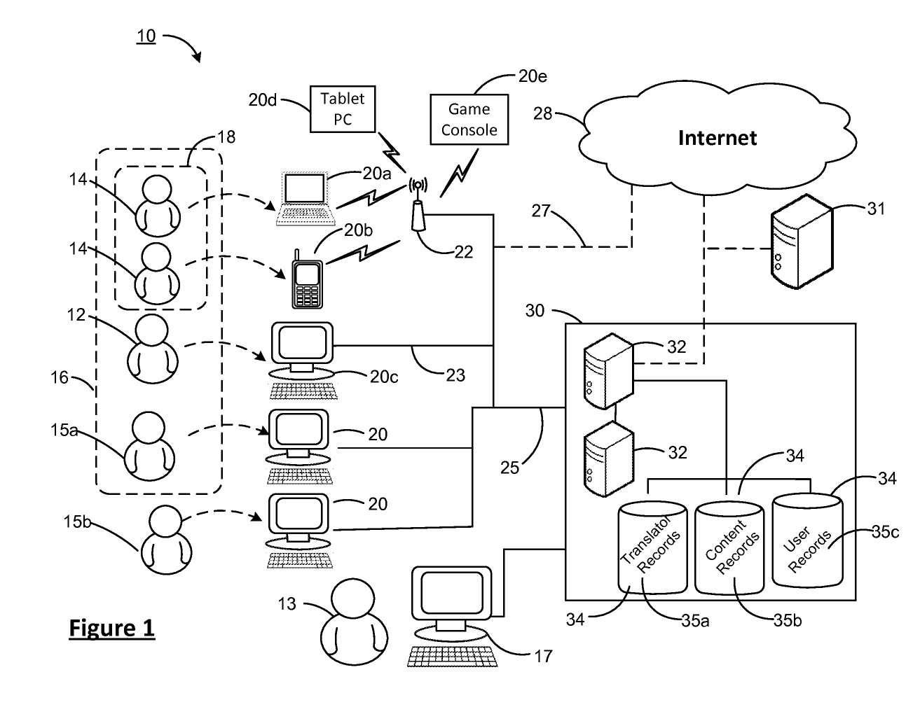

Referring now to FIG. 1, illustrated therein is a system 10 with components configured for multi-lingual translation of content according to some embodiments. The system 10 as shown is an electronic learning system or eLearning system. However, in other instances the system 10 may not be limited to electronic learning systems and it may be other types of systems.

System 10 is operable to provide multi-lingual translation for content of an electronic learning platform. System 10 is operable to provide a mechanism by which a user (e.g. author, translator) can author content in more than one language. In accordance with some embodiments, system 10 may provide convenient user interface components that allow the user to maintain context for the content to be translated by logically grouping content based on course, related subject matter, and the like.

In accordance with some embodiments, system 10 is operable to group or centralize translated content, allowing a permitted user to find and edit existing translations. System 10 is operable to provide a mechanism for identifying those translations that have been updated. This is facilitated by an association or link between each translation and the specific revision of that content used for the translation in its source language. As an illustrative example, a user who is responsible for the French translations would receive an alert indicating that the English translation (source content for the French translation) had been updated. Upon receipt of the alert, the user may choose to sign off on the existing French translation, or update it accordingly.

In accordance with some embodiments, a user or translator can select one or more preferred source languages and one or more translation languages. System 10 is operable to locate content in the preferred source language(s) to be translated to the translation language(s). That way, even if the content was originally authored in English, a German translator can reference the Spanish translation if they are more familiar with Spanish than English, as indicated by the preferred source language.

In accordance with some embodiments, system 10 is further operable to spot translated content that has equivalent values in its source language but not in its translations. The different equivalent values may suggest that translation is out of date or in error.

System 10 is operable to receive translated content in a translation language, where the translated content is generated based on content in a source language. System 10 is further operable to receive an update to the content in the source language. System 10 is operable to maintain content records 35b with a source content record for the content in the source language and a translation content record for the translated content in the translation language. System 10 is operable to link the translation content record to the source content record through a reference, association or other linking mechanism. The source content record may be specific to a translator 15a, 15b (referred to generally as translator 15 herein) such as the content record used by the particular translator 15 to make a translation. The source content record may also be detected as any record used as a basis for a translation, regardless of a particular translator 15.

System 10 is further operable to receive a corresponding update to the translated content in the translation language based on the linking between the translation content record and the source content record.

Using the system 10, one or more users 12, 14, 15 may communicate with an educational service provider 30 to participate in, create, translate, and consume electronic learning services, including educational courses. In some cases, the educational service provider 30 may be part of (or associated with) a traditional “bricks and mortar” educational institution (e.g. a grade school, university or college), another entity that provides educational services (e.g. an online university, a company that specializes in offering training courses, an organization that has a training department, etc.), or may be an independent service provider (e.g. for providing individual electronic learning).

Each user 12, 14, 15 of the system 10 may be associated with a user account which may govern access permissions and set configurations for the user. For example, the user account may include one or more preferred languages for a user 12, 14, 15. The preferred languages may relate a language that the user 12, 14, 15 consumes content in, a language that the user 12, 14, 15 translates content from (e.g. source language), and a language that the user 12, 14, 15 translates content into (e.g. translation language). The preferred languages may be ranked in priority such that the first language in the ranking is the most preferred language and the last language in the ranking is the least preferred language. That way, if content is not available in the most preferred language there are fallback languages for the provision of content. The user account may also include a region for the user 12, 14, 15. The region may be used to select a preferred language for provision of content to the user 12, 14, 15. For example, if the user 12, 14, 15 indicates the region is Australia then the preferred language may be English-Australian, and fallback languages may include English-Canadian, English-UK, and English-US.

It should be understood that a course is not limited to courses offered by formal educational institutions. The course may include any form of learning instruction offered by an entity of any type. For example, the course may be a training seminar at a company for a group of employees or a professional certification program (e.g. CFA, PMP, CMA, etc.) with a number of intended participants.

In some embodiments, one or more educational groups can be defined that includes one or more of the users 12, 14, 15. For example, as shown in FIG. 1, the users 12, 14, 15a may be grouped together in an educational group 16 representative of a particular course (e.g. History 101, French 254), with a first user 12 or “instructor” being responsible for organizing and/or teaching the course or group (e.g. developing lectures, preparing assignments, creating or authoring educational content etc.), another user 15a being responsible for translating content for the course or group, while the other users 14 or “learners” are consumers of the course content (e.g. users 14 are enrolled in the course). Other users 15b may not be part of a defined group and may be responsible for translating content for multiple groups and courses.

In some examples, the users 12, 14, 15 may be associated with more than one educational group (e.g. the users 14 may be enrolled in more than one course, a user 12, 14 may be enrolled in one course and be responsible for teaching another course, a user 12 may be responsible for teaching a plurality of courses, a user 15 may be responsible for translating content for a plurality of courses or groups, and the like).

In some cases, educational sub-groups may also be formed. For example, the users 14 are shown as part of educational sub-group 18. The sub-group 18 may be formed in relation to a particular project or assignment (e.g. sub-group 18 may be a lab group) or based on other criteria. In some embodiments, due to the nature of electronic learning, the users 14 in a particular sub-group 18 need not physically meet, but may collaborate together using various tools provided by the educational service provider 30. A user 15a may be responsible for translating content for a sub-group 18.

In some embodiments, other groups 16 and sub-groups 18 could include users 14 that share common interests (e.g. interests in a particular sport), that participate in common activities (e.g. users that are members of a choir or a club), and/or have similar attributes (e.g. users that are male, users under twenty-one years of age, etc.). A user 15 may be responsible for translating content for the related groups 16 and sub-groups 18 as the content may have a similar context.

Communication between the users 12, 14, 15 and the educational service provider 30 can occur either directly or indirectly using any one or more suitable computing devices. For example, the user 12, 14, 15 may use a computing device 20 having one or more client processors such as a desktop computer that has at least one input device (e.g. a keyboard and a mouse) and at least one output device (e.g. a display screen and speakers).

The computing device 20 can generally be any suitable device for facilitating communication between the users 12, 14, 15 and the educational service provider 30. For example, the computing device 20 could be a laptop 20a wirelessly coupled to an access point 22 (e.g. a wireless router, a cellular communications tower, etc.), a wirelessly enabled personal data assistant (PDA) 20b or smart phone, a terminal 20c, a tablet computer 20d, or a game console 20e operating over a wired connection 23.

The computing devices 20 may be connected to the service provider 30 via any suitable communications channel. For example, the computing devices 20 may communicate to the educational service provider 30 over a local area network (LAN) or intranet, or using an external network (e.g. by using a browser on the computing device 20 to browse to one or more web pages or other electronic files presented over the Internet 28 over a data connection 27). Computing devices 20 may store one or more applications that may interact with or run within system 10.

In some examples, one or more of the users 12, 14, 15 may be required to authenticate their identities in order to communicate with the educational service provider 30. For example, each of the users 12, 14, 15 may be required to input a user identifier such as a login name, and/or a password associated with that user 12, 14, 15 or otherwise identify themselves to gain access to the system 10. The login name and password may be stored in a user account associated with the user 12, 14, 15 where the user account may govern access permissions and setting configurations associated with the user 12, 14, 15.

In some examples, one or more users 12, 14, 15 (e.g. “guest” users) may be able to access the system without authentication. Such guest users 12, 14, 15 may be provided with limited access, such as the ability to review one or more components of the course to decide whether they would like to participate in the course, or translate content for the course but without the ability to post comments, edit content, or upload electronic files.

In some embodiments, the wireless access points 22 may connect to the educational service provider 30 through a data connection 25 established over the LAN or intranet. Alternatively, the wireless access points 22 may be in communication with the educational service provider 30 via the Internet 28 or another external data communications network. For example, one user 14 may use a laptop 20a to browse to a webpage that displays elements of an electronic learning system (e.g. a course page).

Educational service provider 30 may be implemented using servers 32 and data storage devices 34 configured with database(s) or file system(s), or using multiple servers or groups of servers 32 and data storage devices 34 distributed over a wide geographic area and connected via a network (e.g. Internet 28). Educational service provider 30 may reside on any networked computing device including a processor and memory, such as an electronic reading device, a personal computer, workstation, server, portable computer, mobile device, personal digital assistant, laptop, smart phone, WAP phone, an interactive television, video display terminals, gaming consoles, and portable electronic devices or a combination of these.

Educational service provider 30 may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Educational service provider 30 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like. System 10 may include one or more input devices, such as a keyboard, mouse, camera, touch screen and a microphone, and may also include one or more output devices such as a display screen and a speaker.

Educational service provider 30 has a network interface in order to communicate with other components, to serve web pages, and perform other computing applications by connecting to any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Educational service provider 30 may also include an internal network to connect components of the education service provider 30 such as the servers 32 and the data storage devices 34.

Educational service provider 30 generally includes a number of functional components for facilitating the provision of electronic learning services, and the translation of content for the electronic learning services. For example, the educational service provider 30 generally includes one or more processing devices such as servers 32, each having one or more processors. The processors on the servers 32 will be referred to generally as “remote processors” so as to distinguish from client processors found in computing devices (20, 20a-20e). The servers 32 are configured to collect information, send information (e.g. electronic files such as web pages) to be displayed on one or more computing devices 20 in association with the electronic learning system 10 (e.g. course information), receive translated content, update content, and the like. In some embodiments, a server 32 may be a computing device 20 (e.g. a laptop or personal computer).

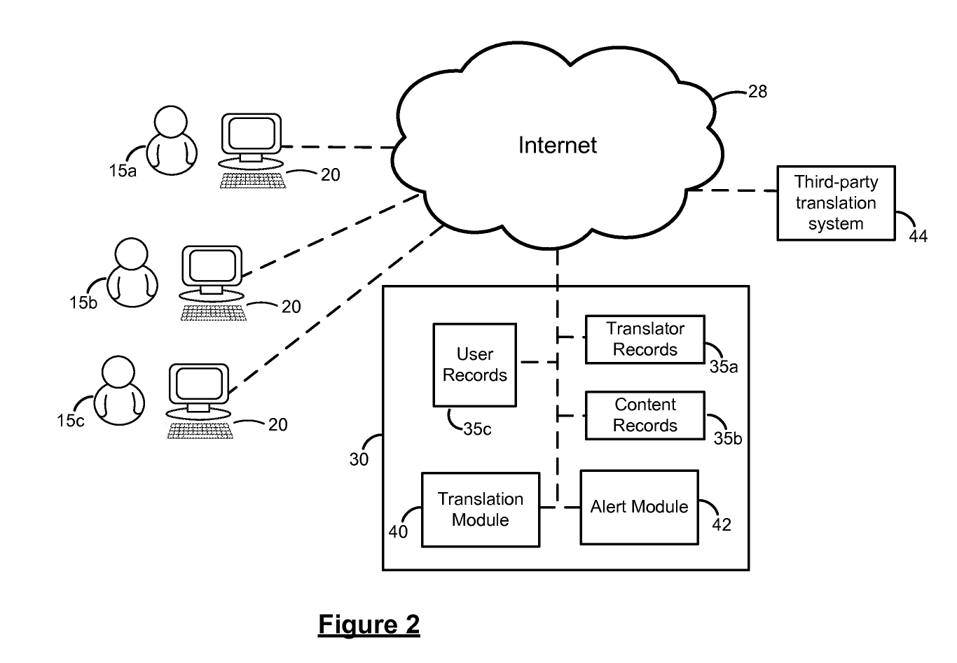

Educational service provider 30 also generally includes one or more data storage devices 34 (e.g. memory, etc.) that are in communication with the servers 32, and could include a relational database (such as a SQL database), or other suitable data storage devices. The data storage devices 34 are configured to host data 35 about the courses offered by the service provider (e.g. the course frameworks, educational materials to be consumed by the users 14, records of assessments done by users 14, content authored by users 12, 14, 15, content translated by users 15, etc.). The data storage devices 34 may also host translator records 35a, content records 35b, and user records 35c which are executed by server 32. External applications 37 may also interact with educational service provider 30 which may be temporarily or permanently loaded onto data storage devices 34 and may be executed by server 32. Further details will be provided herein in relation to FIG. 2.

The data storage devices 34 may also store authorization criteria that define what actions may be taken by the users 12, 14, 15 where the authorization criteria may be stored in translator records 35a or user records 35c. In some embodiments, the authorization criteria may include at least one security profile associated with at least one role. For example, one role could be defined for users 12, 15 who are primarily responsible for developing an educational course, translating content, teaching, and assessing work product from other users 14 for that course. Users 12, 15 with such a role may have a security profile that allows them to configure various components of the course, post assignments, add assessments, evaluate performance, add content items, edit content items, translate content items, and the like.

In some embodiments, some of the authorization criteria may be defined by specific users 13 who may or may not be part of the educational community 16. For example, administrator users 13 may be permitted to administer and/or define global configuration profiles for the system 10, define roles within the system 10, set security profiles associated with the roles, and assign the roles to particular users 12, 14, 15 in the system 10. In some cases, the users 13 may use another computing device (e.g. a desktop computer 17) to accomplish these tasks.

The data storage devices 34 may also be configured to store other information, such as personal information about the users 12, 14, 15 of the system 10, preferred languages for the users 12, 14, 15, information about which courses the users 14 are enrolled in, roles to which the users 12, 14, 15 are assigned, content assigned to users 15 for translation, particular interests of the users 12, 14, 15, content for the courses from users 12, 14, 15 and so on. This other information may also be stored in translator records 35a and user records 35c.

In some embodiments, external computing applications may interact with educational service provider 30 and users 12, 14, 15 such as external computing applications residing on third-party translation systems. External computing applications may also be launched, invoked, executed and so on by educational service provider 30 and users 12, 14, 15. Accordingly, computing applications may be stored internally within educational service provider 30, computing applications may be stored externally to educational service provider 30 but may interact therewith, or a combination thereof.

In some embodiments, some of the application account authorization criteria (e.g. permissions) may be defined by specific users 13, 15b who may or may not be part of the educational community 16. For example, administrator users 13 may be permitted to administer and/or define global configuration profiles for the system 10, define roles within the system 10, set security profiles associated with the roles, create and modify application accounts, and assign the roles to particular applications. In some cases, the users 13 may use another computing device (e.g. a desktop computer 17) to accomplish these tasks. Other users 15b may be responsible for translating content for the educational community 16.

In some embodiments, the system 10 may also have one or more backup servers 31 that may duplicate some or all of the data 35 stored on the data storage devices 34. The backup servers 31 may be desirable for disaster recovery (e.g. to prevent undesired data loss in the event of an event such as a fire, flooding, or theft). In some embodiments, the backup servers 31 may be directly connected to the educational service provider 30 but located within the system 10 at a different physical location.

The servers 32 and data storage devices 34 may also provide other electronic learning management tools (e.g. allowing users to add and drop courses, communicate with other users using chat software, etc.), and/or may be in communication with one or more other vendors that provide the tools. An example electronic learning management tools may include a tool for multi-lingual translation of content for the educational community 16.

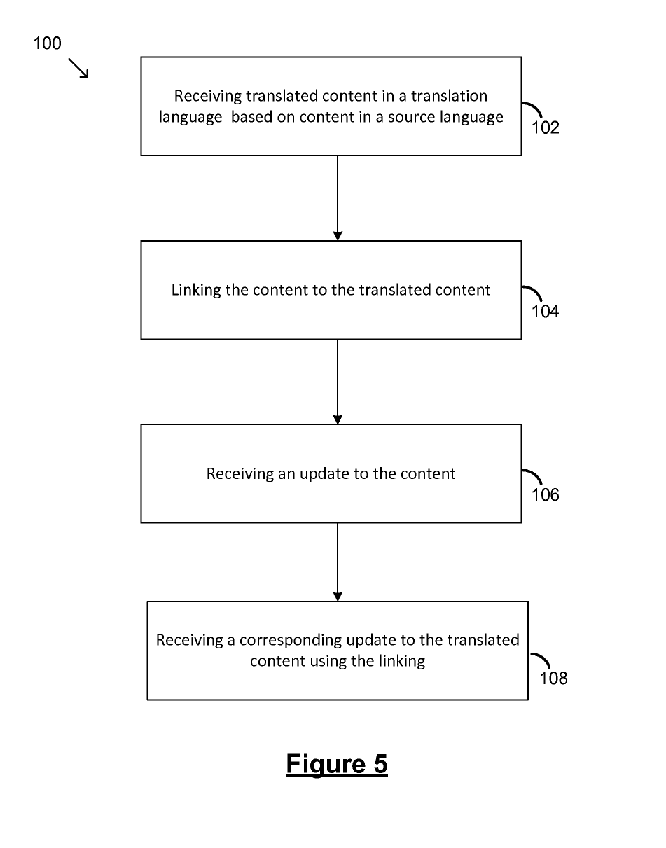

Referring now to FIGS. 2 and 5, which show a block diagram of educational service provider 30 and a flowchart diagram of method 100 for multi-lingual translation of content for an electronic learning platform in accordance with embodiments described herein. In this example, a translation module 40 and an alert module 42 may reside on data storage device 34 and may be executed by a server 32 of educational service provider 30. In other examples, a translation module 40 and an alert module 42 may be external to educational service provider 30 and interact therewith via a network. For example, a translation module 40 and an alert module 42 may reside on an external data storage device and may be executed by an external server (or server 32) connected via Internet 28 or another network.

At 102, a translation module 40 is operable to receive translated content in a translation language. The translated content is generated based on source content in a source language. Accordingly, source content may refer to content used as a basis for a translation. The source content and the translated content may be stored by educational service provider 30 as content records 35b. A translator 15a, 15b, 15c (referred to generally herein as translator 15) may use a computing device 20 to view the source content and provide the translated content to educational service provider 30 via Internet 28. A third-party translation system 44 may also provide the translated content.

A user 12, 14, 15 may access educational service provider 30 using a computing device 20 configured with a user interface, a hardware interface, an application programming interface, and the like. A user 12, 14, 15 may register with educational service provider 30 by creating an account with attributes (e.g. name, region, contact), preferences (e.g. preferred languages, content type, course), and permissions for content that the user 12, 14, 15 accesses, creates, edits, translates, consumes, and the like. For example, a user 12 may be an educator and may be permitted to create content for a course. The created content may be stored by educational service provider 30 as content records 35b (which may also have corresponding attributes and permissions). The user 12 may own or be responsible for the created content. In some examples, only the user 12 that created the content may be able to update, delete or edit the created content record. In other examples, a group of users 12, 14, 15 may be able to update, delete or edit the created content record, as specified in permissions of the content record 35b or their corresponding user record 35c.

A translator 15 may be responsible to translate content (e.g. source content, translated content). A translator 15 may access educational service provider 30 using a computing device 20 configured with a user interface, a hardware interface, an application programming interface, and the like. A translator 15 may register with educational service provider 30 by creating an account with attributes, permissions, and preferences, such as preferred languages, along with translated or source content that the translator 15 owns or is responsible for. The translator account may be stored by educational service provider 30 as a translator record 35b. Alternatively or additionally, the translator account may be stored as a user record 35c generally, as translators 15 are specific types of users 12, 14, 15.

Content may be translated into multiple languages. A translator 15 may translate already translated content into another translation language, or may translate source content into another translation language, depending on language preferences or capabilities of the translator. That is, the translator 15 may use original source content or already translated content as a basis for another translation. Accordingly, source content may refer generally to content used as a basis for a translation. For example, if the source content is in English and translated content is in Spanish and the translator understands Spanish and French then the Spanish translated content may be used as a basis or source for a French translation. As another example, if the translator understands English and French then the English content may be used as a basis or source for a French translation. In accordance with some embodiments, translation module 40 is further operable to receive additional translated content in an additional translation language. The additional translated content may be stored as content records 35b.

At 104, the translation module 40 is operable to link the content in the source language (i.e. source content item or content record 35b) to the translated content in the translation language (i.e. translated content item or content record 35b). The link enables edits or updates to source or translated content to trigger alerts for corresponding updates to be made to the translated or source content. Translation module 40 is further operable to link additional translated content in an additional translation language to content in the source language, or other translated content in another translation language depending on what content was used to generate the additional translation. The linking may include a reference or key to a source content record 35b (e.g. an identifier, author) within a translation content record 35b, for example.

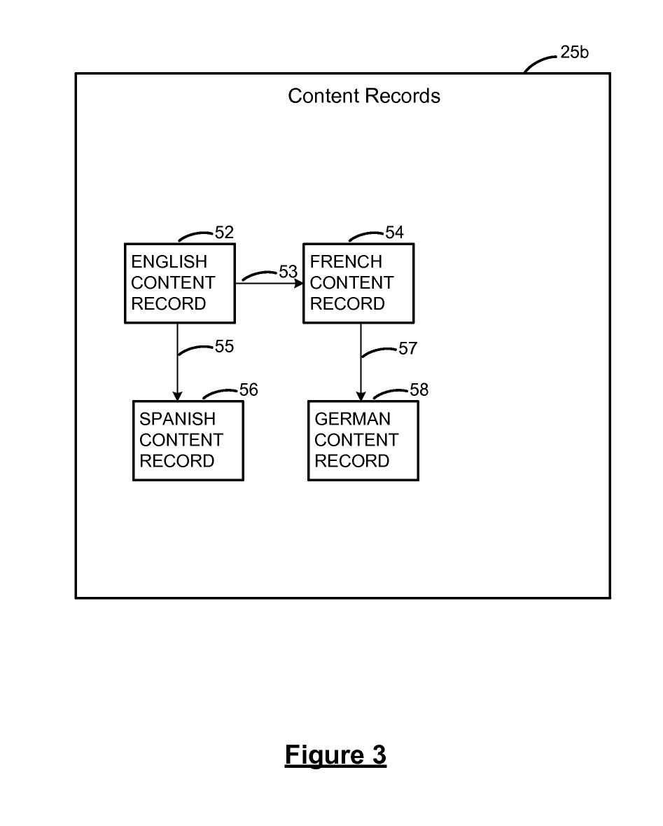

Referring now to FIG. 3 there is shown a schematic diagram of content records 25b in accordance with embodiments described herein. As an illustrative and non-limiting example, source content may be initially created in English and stored as an English content record 52. Translation module 40 may receive translated content in French and the English content record 52 may be used as the basis or source for the French translation. The translated content in French may be stored as a French content record 54. If the English content record 52 is used as the source content record for the French translation then translation module 40 is operable to create a link 53 between the English content record 52 and the French content record 54. The link 53 may be recorded in the French content record 54 such as a reference or attribute for an identifier or key corresponding to the English content record 52 (e.g. source content), the author of the English content record 52 (e.g. author of source content), and the like. The French content record 54 may also include a reference or attribute for the translator 15 or author for the translated content.

Additional translations may be generated based on the original source content (e.g. English content record 52). For example, a Spanish translation may be generated based on the English content record 52 and stored as a Spanish content record 56. If the English content record 52 is used as the source content record for the Spanish translation then there will be a link 55 between the English content record 52 and a Spanish content record 56. The link 53 may be recorded in the Spanish content record 56 such as a reference or attribute for an identifier or key corresponding to the English content record 52 (e.g. source content), the author of the English content record 52 (e.g. author of source content), and the like. The Spanish content record 56 may also include a reference or attribute for the translator 15 or author for the translated content.

Additional translations may be generated based on the translated content (e.g. French content record 54, a Spanish content record 56). For example, a German translation may be generated based on the French content record 54 and stored as a German content record 58. If the French content record 54 is used as the source content record for the German translation then there will be a link 57 between the French content record 54 and the German content record 58. The link 57 may be recorded in the German content record 58 such as a reference or attribute for an identifier or key corresponding to the French content record 54 (e.g. source content), the author of the French content record 54 (e.g. author of source content), an identifier or key corresponding to the English content record 52 (e.g. the source content used for the source content French translation). The German content record 58 may also include a reference or attribute for the translator 15 or author for the translated content.

At 106, the translation module 40 is operable to receive an update to source content in the source language. Source content may be content used as a basis for a translation. The translation module 40 is operable to receive a variety of types of updates. For example, a new paragraph or sentence may be added to the source content. As another example, an upgrade to educational service provider 30 (e.g. introduction of a new version of software, new module, new feature) may result in an update to source content, such as a new user interface button with text. As a further example, a process of educational service provider 30 may add or remove content resulting in an update. Source content and updates thereto may be managed as different content records 35b, such as source content record version 1 and source content record version 2 (where version 2 includes the update).

A translator 15 may generate corresponding updates to content that they initially translated, own, are responsible for, is related to other translated content, part of their course, required in one or more of their preferred languages, and the like. The corresponding updates are based on updates made to the source content, or updates made to other translated content depending on the content used to generate the translation, or the content that is generally available to be used as a basis for a translation. Accordingly, the translator 15 may be notified of updates made to the source content in order to make corresponding updates to the translated content.

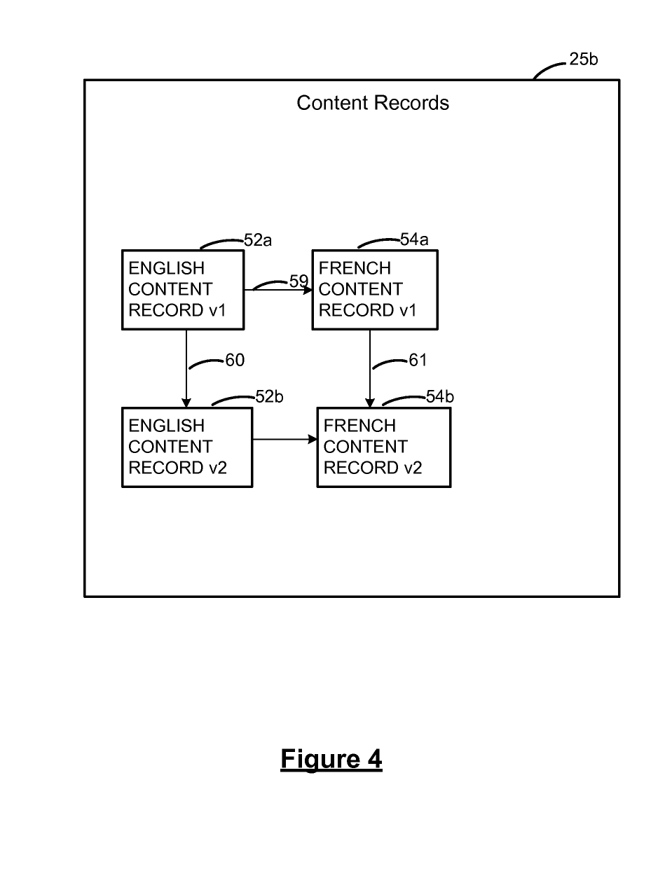

Referring now to FIG. 4, there is shown a schematic diagram of content records 25b as an illustrative non-limiting example embodiment. In accordance with some example embodiments, an update to a content record may be reflected in a new version of the content record. As shown, an English content record version one 52a may be updated such that an English content record version two 52b reflects the update. Translation module 40 is operable to create a link 60 between English content record version one 52a and English content record version two 52b to indicate that they are related. In accordance with other example embodiments, updates may be reflected in the original content record.

Referring back to FIG. 5, at 108, the translation module 40 is operable to receive a corresponding update to the translated content in the translation language using the linking between the source content and the translated content. For example, a new paragraph may be added to the source content and a corresponding translated paragraph may be added to the translated content.

In accordance with some embodiments, translated content and updates thereto may be managed as different versions of content records 35b. As shown in FIG. 4, a French content record version #1 54a may be updated such that a French content record version #2 54b reflects the update. Translation module 40 is operable to create a link 61 between French content record version #1 54a and French content record version #2 54b to indicate that they are related. In accordance with other example embodiments, updates may be reflected in the original translation content record.

Accordingly, a user 12, 14, 15 may create content in a source language, such as for example English. The content becomes content record 35b version #1 of the English source. A translator A 15 translates the content from English to French. The translated content becomes content record 35b version #1 of the French translation. Another translator B 15 translates the content from French to Spanish. The translated content becomes content record 35b version #1 of the Spanish translation. The original user 12, 14, 15 now changes or updates the English content record 35b, which now becomes content record 35b version #2 of the English source. Translator A 15 may be notified that their French translation is out of date, so they re-translate the content (generating a corresponding update) which becomes content record 35b version #2 of the French translation. Finally, translator B 15 is notified that their Spanish translation is out of date, they re-translate the content (generating a corresponding update) which becomes content record 35b version #2 of the Spanish translation.

In accordance with embodiments involving multiple translations of the same content, the translation module 40 is operable to receive a corresponding update to the additional translated content in the additional translation language(s) using the linking between content records 35b.

In accordance with some embodiments, an alert module 42 is operable to indicate that there has been an update to the source content which requires a corresponding update to the translated content. The source content may be originally created content or translated content used for a subsequent translation.

The alert module 42 may use the linking between the source content and the translated content to provide an indication of the update. The source content may be used as a basis for multiple translations and the alert module 42 may use the linking between the source content and the multiple translations to provide an indication of the update for each of the multiple translations. The alert module 42 may first determine that the update is a major update that exceeds a predetermined threshold. That is a typo or grammatical correction in the content may be a minor update that may not exceed a threshold and an indication or alert may not be provided. Accordingly, alert module 42 is operable to classify an update as either a minor update or a major update in order to determine whether or not to send an alert. The alert module 42 may include predefined thresholds, rules, definitions, and the like in order to classify the update as a major update or a minor update.

A user 12, 13, 14, 15 (whether a translator 15 or not) may receive an alert or other indication when an update is made to content of interest. For example, a user 12, 13, 14, 15 may have read a content item and may receive an alert if the content item they read is updated. For example, a user 12, 13, 14, 15 may follow, listen to, or otherwise monitor a content item and receive alerts when it is updated.

An update to source content may result in a chain of updates to translated content. For example, original source content may be in English which may be used as a basis for French translated content. The alert module 42 may use the linking between the English content and the translated French content to provide an indication of the update to the English content. This may trigger a corresponding update to the French content. The French content may be used as a basis for Spanish translated content. The alert module 42 may use the linking between the French content and the translated Spanish content to provide an indication of the update to the French content. This may trigger a corresponding update to the Spanish content. The Spanish content may be used as a basis for Portuguese translated content. The alert module 42 may use the linking between the Spanish content and the translated Portuguese content to provide an indication of the update to the Spanish content. This may trigger a corresponding update to the Portuguese content, and so on.

When performing translations, a translator 15 may be able to see a full translation chain that was used to arrive at the current translation term. For example: “hello” (English)->“bonjour” (French)->“hola” (Spanish). This will be beneficial in the scenario where the translator 15 is fluent or partially fluent in more than one of the parent translations as this additional information provides them with more context with which to perform the translation.

As noted, alert module 42 is operable to provide an indication that an update to content may require a corresponding update to the content in another language. Alert module 42 is further operable to provide an indication when a translation of content is required based on new content. The alert may be based on an update to content which requires a corresponding update to content in another language. The alert may be specific to a translator 15 or other user 12, 13, 14, 15. The alert may be based on the language required for the translation. For example, if a translator 15 has a preferred language corresponding to newly authored content and another preferred language corresponding to a required translation then the translator 15 may receive an alert indicating that a translation is required. The alert may be based on a course that content forms part of. For example, a translator 15 may be responsible to translate English content into Spanish content for a specific course (or set of courses). The translator may have both English and Spanish as a preferred language. When new English content is generated or English content is updated then the alert module 42 is operable to provide an indication that a translation or corresponding update is required.

The alert module 42 may provide the indication in a variety of ways. For example, the alert module 42 is operable to send a notification, such as a message or email to the translator 15 responsible to update the translated content or translate newly generated content. As another example, the alert module 42 is operable to provide a notification or alert in a toolbar of a user interface accessed by the translator 15. As a further example, the alert module 42 is operable to generate a listing of all updates required for translated content. When a translator 15 logs into a user interface on computing device 20 used to access educational service provider 30 the listing is displayed to the translator to indicate which translated content requires updating.

The translation module 40 is operable to log a history of all translations made by a particular translator 15 which may be stored as entries in the corresponding translator record 35a. The log may refer to the source content or language used to make the translation and other data related to the translation.

In accordance with some embodiments, the translation module 40 is operable to provide a translation chain for a term of the source content, a term of translated content, and terms for any additional translations. The translation chain may include the original source term and the corresponding translated term(s). The translation chain may facilitate error detection and correction. For example, one source term may lead to different translation terms, which may or may not be an error depending on the context of the term. This may be flagged for a translator 15 for review and correction. The translation chain may also assist a third-party translation system 44 when making future translations from the source language to a translation language, as the term in the source language may be linked to the term in the translation language in the translation chain.

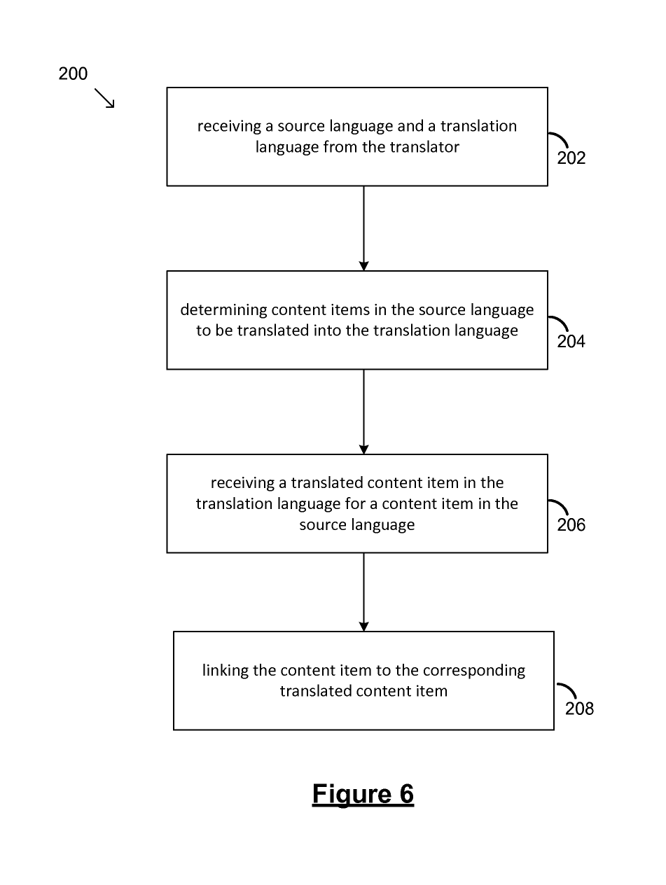

Referring now to FIG. 6, there is shown a flowchart diagram of another method 200 for multi-lingual translation in accordance with embodiments described herein. System 10 is operable to provide translation management system with a user interface to enable translators 15 and other users 12, 13, 14 to locate un-translated content and view translated content.

At 202, translation module 40 is operable to receive preferred languages from a translator 15 or other user 12, 13, 14. The preferred language may include one or more source languages (corresponding to languages of current content items) and one or more translations language (corresponding to languages current content items need to be translated into). The translation module 40 may receive the preferred languages from the translator record 35a corresponding to the translator 15. The translator record 35a corresponding to the translator 15 may be retrieved when the translator 15 logs into educational service provider 30. In some embodiments, instead of or in addition to a preferred language, translation module 40 is operable to receive an identifier from a user 12, 13, 14, 15. The identifier may be used by translation module 40 to locate a user record 35c or translator record 35a which may contain one or more preferred languages as an attribute or preference thereof.

The preferred languages may be used by translation module 40 to locate un-translated content in a preferred language (e.g. source language) to be translated into another preferred language. The un-translated content may also be in a language that is an alternative to a preferred language. The un-translated content may also need to be translated into a language that is an alternative to a preferred language The preferred languages may be used by translation module 40 to locate translated content in a preferred language (e.g. source language) for review by a user 12, 13, 14, 15.

The preferred languages may also be determined based on translation requirements of the educational service provider 30. For example, a course may be expanded from English and Spanish content to French content. If a translator 15 indicates that they can understand English, Spanish, Italian and French then only Spanish may be a preferred language if that is the only current translation requirement of educational service provider 30.

The preferred languages may be provided as a priority listing, where each language of the priority listing is ranked from most preferred to least preferred. For example, a translator 15 may be more comfortable with German and French and may also understand Spanish but less so than German and French. The priority listing provides ranked alternatives that may be matched to translation requirements of educational service provider 30. For example, if only a Spanish translation is required by educational service provider 30 then Spanish may be a preferred language of the translator 15 even though the translator 15 is more comfortable with German and French.

A preferred language may also be associated with regions. For example, a translator 15 may indicate that a preferred language is English-Australian or French-Canadian. Additional preferred languages may be determined based on the region. For example, an additional preferred language may be English-Canadian (based on English-Australian).

Accordingly, preferred languages may be based on preferences, educational service provider 30 translation requirements, regions, rankings or listings. A preferred language for a translator 15 would include a language that the translator 15 is comfortable with for performing translations, fluent in, comprehends, and the like. Educational service provider 30 enables a translator 15 to configure their preferred languages as preferences in the corresponding translator record 35a. For example, a translator record 35a may include two or more preferred languages in which the corresponding translator 15 is comfortable with for performing translations (e.g. a source language and a translation language).

The preferred languages may not be provided by a translator 15 and may also be provided based on the language capabilities of a third-party translation system 44. A third-party translation system 44 may perform some translations and may generate translated content from source content.

At 204, translation module 40 is operable to identify content items for provision to a translator 15 or user 12, 13, 14, 15. The contents items may be translated content for review by a user 12, 13, 14, 15 or content to be translated by a translator 15. The content items may be used to create a listing of content items that may be translated by translator.

Accordingly, the preferred language may be used by translation module 40 to filter content items. Other factors may also be used to filter content records for provision to a translator 15. For example, a translator 15 may be associated with one or more courses and translation module 40 may identify only content items that are associated with the course. The course may only be offered in two or three languages, so not all translations are required. Accordingly, attributes of the course may be used by translation module 40 to identify content items to be translated by translator 15. The content items may be associated with an author or owner, and only specific translators 15 may be permitted to translate content for the owner. Accordingly, attributes of the owner or author of content may be used to identify content to be translated by a particular translator 15.

Translation module 40 is operable to identify the content items using preferred languages associated with the translator 15 or other user 12, 13, 14, 15. The content items may be in a preferred language (e.g. source language) to be translated into another preferred language (e.g. translation language). Translation module 40 is operable to identify content to be translated based on the preferred languages and the translation requirements of educational service provider 30. For example, educational service provider 30 may have content records 35b in English and may require corresponding content records 35b in Spanish (e.g. content items to be translated into Spanish). A translator 15 may indicate that their preferred languages are English and Spanish. Translation module 40 is operable to identify the English content records 35b as content items in a source language (e.g. English) to be translated into a translation language (e.g. Spanish).

Translation module 40 is operable to identify the content items available in preferred languages associated with a user 12, 13, 14, 15. A user 12, 13, 14, 15 may request to review content items in a preferred language, such as content items associated with a course or assignment.

In accordance with some embodiments, translation module 40 is further operable to identify the content items using an identifier associated with a user 12, 13, 14, 15. For example, an identifier may be provided when a user 12, 13, 14, 15 logs into educational service provider 30. The identifier may be associated with one or more content records 35b that are identified by translation module 40 as the content items. For example, the content records may have been authored or translated by the user 12, 13, 14, 15 associated with the identifier.

Translation module 40 may determine the content items to be to be translated into a translation language using other criteria in addition or alternative to preferred languages, identifiers and the like. For example, translation module 40 is operable to determine the content items (e.g. those in the source language to be translated into a translation language) based on a course associated with a translator 15 or other user 12, 13, 14, 15. Translation module 40 is operable to determine content items that are only associated with a course, and not all content records 35b stored by educational service provider 30. As another example, translation module 40 is operable to determine content items based on a category of work, such as science, history, geography, English, or components of system 10 such as user interface, and the like.

Translation module 40 may determine the content items based on updates made to corresponding content in another language. As described at FIG. 5 step 106, a source content item may be updated which may require a corresponding update to the associated translated content. In other embodiments, updates to content in a language may trigger an update to corresponding content in another language regardless of which content was the source content. For example, content may be originally authored in English which may be translated into French. The French content may be subsequently updated which may trigger an update to the English language. Translation module 40 may identify content items that require updating based on updates made to corresponding content in another language.

Translation module 40 is operable to provide a translation management interface. The translation management interface may present a translator 15 with a listing or display of content items in a preferred source language to be translated into a preferred translation language. The listing may include content items that require updates based on updates made to corresponding content in another language. The translator 15 may select a content item and provide translated content to perform the translation or update. The translator 15 can drill into a portion (or all) of the content items in the listing to perform translations.

Translation module 40 is operable to provide a grouping of identified content records and any associated translations to provide a centralized view of associated translations. This may facilitate translations as a translator 15 will have reference to content in multiple languages that the translator 15 may understand, and may see what translations are required. This also provides a centralized view of associated translations to users 12, 13, 14, 15 for review. That is, translation module 40 is operable to group content to be translated to divide the groups of translations amongst multiple translators. The listing may be a global listing based on all content available within education service provider 30, a course specific listing, subject matter specific listing and so on. Accordingly, the content in the listing may be logically grouped. The listing may be based on a priority or ranking of importance for the content, such that more important content is ranked higher in the listing.

In some embodiments, a third-party translation system 44 may provide a machine translation for review and modification by the translator 15. The third-party translation system 44 may learn based on modifications made by the translator 15 to its translation. Identifying and providing a listing of content items may facilitate the translation process.

In accordance with some embodiments, translation module 40 is operable to determine content items in a preferred source language that need to be translated into a fall back translation language that is associated with a preferred language. For example, a fall back translation language may be determined based on a region for the preferred language. A preferred language may be English-Canadian and a fall back preferred language may be English-Australian. As another example, a preferred language may be Spanish and a fall back preferred language may be Portuguese, due to the proximity of Spain and Portugal and similarity of languages.

At 206, translation module 40 is operable to receive a translated content item in a translation language corresponding to a content item in a source language. For example, a translator 15 may select a content item, perform a translation and provide the translated content to translation module 40. When performing a translation, a translation chain may be provided to the translator 15 if the content has been translated into more than one of the preferred languages to assist the translator 15 in making the translation.

Translation module 40 is operable to create a new content record 35b for the new translated content. The translation content record 35b may include a number of attributes including the translator 15 responsible for the translation, author (which may be translator 15), source content record 35b, author of source content record 35b, an identifier, the translated content, a course, and the like.

In accordance with some embodiments, translation module 40 is operable to receive a corresponding update to a content item based on an update to a corresponding content item in another language. Translation module 40 is operable to create a new version of the content record 35b to include the update. Translation module 40 is also operable to modify the initial version of the content record 35b with the update. The update may be made to source content directly used for the translation or source content used for a translation that is in turn used for another translation.

In accordance with some embodiments, a user 12, 13, 14, 15 may review any translation before it is available within education service provider 30. The user 12, 13, 14, 15 may review and approve a translation. The translation may be saved as a draft pending approval. The translation may be saved as a draft by translator 15 and the translator 15 may publish the translation so that it is available within educational service provider 30. Another user 12, 13, 14, 15 may review and approve the translation prior to publication.

In accordance with some embodiments, a translation may be locked from editing (e.g. no edits or changes may be made thereto) until the source content is updated. Accordingly, a final version of a translation may be locked until the source content is updated.

A translator 15 may review source content while making a translation. A translator 15 may determine that the source content contains an error and flag the source content to prompt the author to review and update the error. The author of content may “own” the content such that only they may make edits. In other cases, any or a portion of users 12, 13, 14, 15 may edit content. In such case, the translator may change the source content upon detecting an error.

At 208, translation module 40 is operable to link the content item in the source language to the translated content item in the translation language. The linking may facilitate notifications and alerts when an update is made to a content item that has been translated in order to receive a corresponding update to the translated content to keep it up to date. The linking may also facilitate identification of content items as translation module 40 is operable to group content items based on translations and corresponding source content.

A translator record 35a, a content record 35b, and a user record 35c may include an identifier to retrieve the record or otherwise identify the record. A translator record 35a and a user record 35c may also include a settings field, preferences field, and a permissions field. The permissions field may include a listing of permitted actions and operations for the corresponding user 12, 14, 15. For example, the permissions may permit a user 12, 14, 15 to write data (e.g. a translation) to system 10 but may not permit user 12, 14, 15 to delete data from system 10. The identifier may be a system 10 generated identifier. If a user 14, 12, 15 sends a request to perform an action different than the actions specified in the permissions field then system 10 is operable to deny or reject the request. Alternatively, system 10 may prompt an administrator user 13 to modify the permissions field to include the requested action or operation. Action requests may be sent on a rolling basis or in batch. If one requested action is not permitted then the entire batch may be rejected, or only the not permitted actions. Example settings include: configuration settings, default values, connection information for related third-party systems, and so on. Attributes may identify courses, organizations, groups, and the like.

Further, a translator record 35a, a content record 35b, and a user record 35c may include a tracking log. For example, translation module 40 may be operable to maintain a log of all updates to the content and all corresponding updates to the translated content. The tracking log may contain a record of all operations performed or actions taken by the user 12, 14, 15 or updates to the content, and the like. The tracking log may be useful for error checking and audit purposes. For example, the tracking log may track a variety of fields such as user, action performed, date, before values, and after values, for example. The tracking log may track data for the purposes of security and activity audits, for example.

The content record 50 may also include a creator field to identify the creator of the content. The creator field may be used for notification, alert, reporting and auditing purposes, for example.

A translator record 35a, a content record 35b, and a user record 35c may also include a timeline field which includes a start date/time and an end date/time defining an activation period for the record. The record may only be valid during the activation period. A record may be forgotten and the timeline field may provide a mechanism to limit access to the activation period so that a forgotten account that has expired may not be used to compromise the system 10. The timeline field may be used for reporting and auditing purposes, for example.

Translation module 40 is operable to create records for users 12, 14, 15 and content. Each record may include a number of fields, and corresponding preferences, permissions and settings. Educational service provider 30 is configured to provide an interface (such as a user interface, application interface) to receive input data from users 12, 13, 14, 15 and store the received input data as fields as part of the record. Application interface 42 is operable to store the records in data storage device 34, or another storage device (internal or external). Educational service provider 30 is operable to index the records for retrieval, and link the records for cross referencing. Educational service provider 30 is operable to retrieve stored records via an application identifier, or other field. Educational service provider 30 is operable to update, modify or delete records.

Translation module 40 is operable to receive two or more preferred language from the translator 15 to identify un-translated content for translation. A preferred language may be a source language for existing content. A preferred language may also be a translation language for un-translated content. A translator 15 may make multiple translations of the same content in multiple languages, multiple translations of different content in the same language, and so on.

Translation module 40 is operable to provide content for consumption or review by a user 12, 14, 15 such as a student. Translation module 40 is operable to receive a preferred language from a user 12, 14, 15 and provide content to the user 12, 14, 15 for review. The content may be related to a course of the user 12, 14, 15 or otherwise associated with the user 12, 14, 15.

User 12, 14, 15 may see content in their preferred language if content was originally authored in the user's 12, 14, 15 preferred language or a translation exists for that content in the user's 12, 14, 15 preferred language. Otherwise, translation module 40 is operable to provide content in a fallback language to one of their preferred languages. For example, English-Canada might fall back to English-Great Britain, then English-Australia, then English-United States, in that order (if such content exists). Accordingly, each language may have associated attributes used to identify fallback languages. In other examples, translation module 40 is operable to provide content in the language in which it was originally authored, or an available language that is the most similar to a preferred language. A language model or structure may be used to determine related or similar languages.

A user's 12, 14, 15 preferred language may be determined based on a combination of user preference and organizational or unit overrides. Translation module 40 is operable to select content (if available) for rendering based on the user's 12, 14, 15 preferred language. A translator's 15 source languages may be a language in which a translator is fluent and comfortable performing translations. Content source language may be a language in which a piece of content was originally authored.

An administrator/auditor user 13 may view all categories of translation work, regardless of their preferred languages. An administrator/auditor user 13 may see/monitor metrics pertaining to the different categories of translation work.

Translation module 40 is operable to provide content by determining whether the preferred language corresponds to the source language or the translation language. Upon determining that the preferred language corresponds to the source language, translation module 40 is operable to provide the content in the source language. Upon determining that the preferred language corresponds to the translation language, translation module 40 is operable to provide the translated content in the translation language.

Translation module 40 is operable to receive a region or location from the user, and select content based on the region and the relationship between languages and the region (e.g. Switzerland is close to countries the speak a variety of languages) or location (e.g. specific school specializes in both German and English). The region or location may be used to find alternatives to preferred languages. Upon determining that desired content is not available in a preferred language corresponds to the additional translation language, translation module 40 is operable to provide the translation content as an alternative based on the region, priority listing, default, and so on.

In accordance with some embodiments, alert module 42 is operable to transmit an alert when there is an update to content in one language that has corresponding content in another language. For example, content in French may be translated into content in Spanish. An update to the content in French (e.g. French content record 35b) may trigger an alert for an update to the content in Spanish (e.g. Spanish content record 35b). In such case, an update to the source content (e.g. the content in French used for the translation) triggers an alert. In accordance with some embodiments, an update to translated content may trigger an alert for a corresponding update to be made to source content. For example, an update to the content in Spanish (e.g. Spanish content record 35b) may trigger an alert for an update to the content in French (e.g. French content record 35b). The alert may be triggered based on the linking between content records 35b. The linking may include a reference or key to a source content record 35b (e.g. an identifier) within a translation content record 35b, for example. Further, an update may trigger alerts for updates to corresponding content in multiple languages if there exists translations for the content in multiple languages, such as if content is used as a source for multiple translations.

A translator 15 may review the change made to the source content and may update the translation or indicate that the translation does not require updating in view of the modification. For example, the modification may correct a grammatical error that is not present in the translation. Accordingly, the translator 15 can choose to update the translation or not in response to receiving an alert or other indication.

The translation module 40 is operable to compare source content to corresponding translated content to detect potential errors. For example, source content may have one term or word (e.g. title) and the corresponding translated content may have a paragraph of terms or words. Translation module 40 may flag this as a potential error based on the connection between the one term in the source and the corresponding equivalent of a paragraph of terms in the translation.

As another example, source content may have multiple instances of the same term and the translated content may have different translated terms corresponding to those terms. Translation module 40 may flag this as a potential error based on the connection between the instances of the term in the source and the different corresponding equivalent terms in the translation. That is, the same term may be translated in different ways in the translation. This may be correct (e.g. the same term may be used in different ways) or this may be an error. The flag may trigger alert module 42 to send an alert to prompt translator 15 to review for consistency.

Accordingly, translation module 40 is operable to determine that the translated content comprises a first translated term corresponding to one instance of a term in the source content, and a second translated term corresponding to another instance of the same term in the source content. If the first translated term is different from the second translated term, then translation module 40 is operable to indicate that the first translated term and the second translated term exist for the at least two instances of the term to prompt for review and potential correction.

In accordance with some embodiments, content records 35b may be grouped by a course. A translator 15 may log in to view content ready for translation related to a course that the translator 15 is responsible for. The translator may provide two or more preferred languages to be used by translation module 40 to determine source content in one of the preferred languages and required translations for the source content in one or more of the other preferred languages. Accordingly, translation module 40 is operable to determine content items for a course to be translated into the translation language, where the plurality of content items is in a source language corresponding to one of the preferred languages. For one or more of the plurality of content items, translation module 40 is operable to receive corresponding translated content item(s) in a translation language that corresponds to another of the preferred languages. The translated content is generated based on the respective content item in the source language. Translation module 40 is operable to link the respective content item in the source language to the translated content item in the translation language. Upon detecting an update to a content item, translation module 40 may receive a corresponding update to the corresponding translated content item in the translation language using the linking between the content item and the translated content item.

The translations may be generated internally by translator 15 or externally by a third-party translation system 44. The translation module 40 is operable to facilitate translations by suggesting translation terms for source terms. The suggestions may be based on past translations, third-party translation system 44, and the like.

In accordance with some embodiments, if content does not exists in a preferred language then, as a fallback, translation module 40 is operable to interact with third-party translation system 44 to generate a machine translation in the preferred language.

The scope of the claims should not be limited by the described embodiments and examples but should be given the broadest interpretation consistent with the description as a whole.

1. A computer implemented method for multi-lingual translation of content for an electronic learning platform, wherein the computer comprises a processor and a memory coupled to the processor and configured to store instructions executable by the processor to perform the method comprising:
receiving translated content in a translation language, wherein the translated content is generated based on content in a source language;
linking the content in the source language to the translated content in the translation language;
receiving an update to the content in the source language; and
receiving a corresponding update to the translated content in the translation language using the linking between the content and the translated content.

2. The method of claim 1, further comprising, prior to receiving the corresponding update, indicating the update to the content in the source language using the linking between the content and the translated content.

3. The method of claim 1, further comprising:
receiving additional translated content in an additional translation language, wherein the additional translated content is generated based on the content in the source language;
linking the content in the source language to the additional translated content in the additional translation language; and
receiving a corresponding update to the additional translated content in the additional translation language based on the notification.

4. The method of claim 1, further comprising:
receiving additional translated content in an additional translation language, wherein the additional translated content is generated based on the translated content in the translation language;
linking the translated content in the translation language to the additional translated content in the additional translation language; and
receiving a corresponding update to the additional translated content in the additional translation language based on the linking between the translated content and the additional translation language.

5. The method of claim 4, further comprising indicating the corresponding update to the translated content in the translation language using the link between the content and the translated content.

6. The method of claim 1, wherein the content comprises a term, wherein the translated content comprises a corresponding translated term, wherein the method further comprises:
providing a translation chain, wherein the translation chain comprises the term and the corresponding translated term.

7. The method of claim 4, wherein the content comprises a term, wherein the translated content comprises a corresponding translated term, wherein the additional translated content comprises a corresponding additional translated term, wherein the method further comprises:
providing a translation chain, wherein the translation chain comprises the term, the corresponding translated term, and the corresponding additional translated term.

8. The method of claim 1, wherein the translated content in the translation language is generated by a translator, wherein the method further comprises:
receiving a preferred source language from the translator;
determining that the preferred source language is the source language of the content; and
providing the content in the source language to the translator prior to receiving the translated content in the translation language.

9. The method of claim 1, wherein the translated content in the translation language is generated by a translator, wherein the method further comprises:
receiving a first preferred language and a second preferred language from the translator;
determining that the first preferred language is the translation language and that the second preferred language is the source language; and
providing the content in the source language to the translator prior to receiving the translated content in the translation language.

10. The method of claim 1, further comprising:
receiving a preferred language from a user;
determining whether the preferred language corresponds to the source language or the translation language;
upon determining that the preferred language corresponds to the source language, providing the content in the source language; and
upon determining that the preferred language corresponds to the translation language, providing the translated content in the translation language.

11. The method of claim 10, further comprising:
receiving a region from the user, wherein an additional translation language and the translation language are within the region;
upon determining that the preferred language corresponds to the additional translation language, providing the translation content as an alternative based on the region.

12. The method of claim 2, wherein the method further comprises, prior to the indicating, determining that the update is a major update that exceeds a predetermined threshold.

13. The method of claim 1, wherein the method further comprises maintaining a log of all updates to the content and all corresponding updates to the translated content.

14. The method of claim 1, wherein the content comprises at least two instances of a term, wherein the method further comprises:
determining that the translated content comprises a first translated term corresponding to one instance of the term and a second translated term corresponding to another instance of the term, wherein the first translated term is different from the second translated term; and
indicating that the first translated term and the second translated term exist for the at least two instances of the term.

15. A method of translating content, wherein the translated content in the translation language is generated by a translator, wherein the method further comprises:
receiving a source language and a translation language from the translator;
determining a plurality of content items for a course to be translated into the translation language, wherein the plurality of content items is in the source language; and
for each of the plurality of content items:
receiving a corresponding translated content item in a translation language, wherein the translated content is generated based on the respective content item in the source language;
linking the respective content item in the source language to the translated content item in the translation language.

16. The method of claim 15, further comprising:
receiving an update to a content item of the plurality of content items; and
receiving a corresponding update to the corresponding translated content item in the translation language using the linking between the content item and the translated content item.

17. A system for multi-lingual translation of content for an electronic learning platform comprising a processor and a memory coupled to the processor and configured to store instructions executable by the processor to configure:
a translation module operable to receive translated content in a translation language, wherein the translated content is generated based on content in a source language and receive an update to the content in the source language;
a plurality of content records comprising a source content record for the content in the source language and a translation content record for the translated content in the translation language, wherein the translation content record is linked to the source content record; and
wherein the translation module is operable to receive a corresponding update to the translated content in the translation language based on the linking between the translation content record and the source content record.

18. The system of claim 17, further comprising an alert module operable to indicate the update to the content in the source language using the link between the translation content record and the source content record.

19. The system of claim 17, wherein the translation module is operable to update the source content record to reflect the update to the content in the source language and the translation content record to reflect the corresponding update to the translated content in the translation language.

20. (canceled)
